(19) United States
(12) Patent Application Publication
(10) Pub. No.: US 2024/0024966 A1
(43) Pub. Date: Jan. 25, 2024

(54) POCKET HOLE JIG WITH DUST COLLECTION

(71) Applicant: Hui Chuan Liao, Oakland, CA (US)

(72) Inventors: Hui Chuan LIAO, Oakland, CA (US); Yu-Chen HSIAO, Taichung City (TW); Yin-Liang LIAO, Taichung City (TW)

(21) Appl. No.: 17/814,080

(22) Filed: Jul. 21, 2022

(51) Int. Cl. B23B 47/28; B23B 47/34

(52) U.S. Cl. CPC B23B 47/287; B23B 47/34

(57) ABSTRACT

A pocket hole jig is provided, including a body with a first end having at least one drill entry port in communication with an internal drilling chamber, and a second, opposite end having a chip flute in communication with the drilling chamber; a distance adjustment base configured for contact with a workpiece and is configured so that said body is linearly slidable relative to said base for adjusting drill depth and drilling position of the workpiece; and a dust collector fitting removably attachable to, and in communication with the chip flute, at least one of the dust collector fitting and the chip flute being configured for accommodating a clamp for securing the jig to the workpiece.

### BACKGROUND

The present invention relates to woodworking tools and accessories, and more specifically to a fixture or jig for assisting woodworkers in the creation of pocket holes or oblique holes for fasteners joining wooden pieces either joined at a right angle or co-planar with each other.

Conventional pocket hole jigs or fixtures are known in the art. Such products are typically provided in relatively large, fixed formats, or in relatively small, portable units. The present disclosure will focus mainly on the latter category of products. Among the drawbacks of conventional pocket hole fixtures is the inability to adequately remove sawdust from the workplace as the required holes are drilled. Among other factors, such sawdust impairs the worker's observation of the drilling action, is unpleasant for the worker, and creates a messy work area.

Many conventional portable pocket hole jigs require threaded fasteners for securing the jig in place. Other such units have a fixed or inconveniently placed vacuum collection system. In some cases, clamps are used to secure the pocket hole jig in place on the workpiece, but there is no convenient or effective location for anchoring the clamp on the jig. Accordingly, there is a need for an improved portable pocket hole jig that addresses the drawbacks listed above.

### SUMMARY

The above-listed need is met or exceeded by the present portable pocket hole jig that features a chip flute in close operational relationship to the drilling position of the body for enhancing the evacuation of sawdust and wood chips generated during drilling Another feature of the present portable pocket hole jig is that a dust collection fitting is attachable to the chip flute preferably directly above the drilling position.

Still another feature of the present dust collection fitting is a vacuum connection tube that projects radially from the collection fitting. Due to the rotatable attachment of the dust collection fitting to a main body of the jig, the tube is movable to a variety of user-selected positions to more conveniently position the vacuum collection of generated chips and sawdust. A still further feature of the present portable pocket hole jig is that the dust collection fitting is also configured for accommodating a clamp for holding the jig to the workpiece. Accordingly, the clamp is positionable directly over the drilling position, for increased effectiveness, and is also configured for restraining the vacuum collection fitting in position along with the jig itself. The dust collection fitting is provided with support structure that withstands the forces generated by the clamp so that the fitting does not collapse under the clamp pressure. Yet another feature of the present portable pocket hole drilling jig is that the dust collector fitting is optionally removable, and the chip flute is also constructed and arranged for serving as the clamping point, with similar structural support to withstand clamping forces.

More specifically, a pocket hole jig is provided, including a body with a first end having at least one drill entry port in communication with an internal drilling chamber, and a second, opposite end having a chip flute in communication with the drilling chamber; a distance adjustment base configured for contact with a workpiece and being configured so that said body is linearly slidable relative to said base for adjusting drill depth and drilling position of the workpiece; and a dust collector fitting removably attachable to, and in communication with the chip flute, at least one of the dust collector fitting and the chip flute being configured for accommodating a clamp for securing the jig to the workpiece.

In an embodiment, the dust collector fitting is rotatable relative to the chip flute. Also, the dust collector fitting preferably includes a radially projecting collector tube, and the collector tube has external grooves at a free end for securing a vacuum tube.

In an embodiment, the body is linearly indexable relative to the base. Also, in a preferred embodiment, the dust collector fitting and the chip flute are located above the drilling chamber. In an embodiment, both of the dust collector fitting and the chip flute are configured for accommodating a clamp for securing the jig to the workpiece. As such, both the dust collector fitting and the chip flute are provided with support structure for withstanding clamping forces generated by the clamp.

In another embodiment, a pocket hole jig includes a body with a first end having at least one drill entry port in communication with an internal drilling chamber, and a second, opposite end having a chip flute in communication with the drilling chamber. A distance adjustment base is configured for contact with a workpiece and is configured so that the body is linearly slidable relative to the base for adjusting drill depth and drilling position of the workpiece; and the chip flute is provided with a support grid for accommodating a clamp for securing said jig to the workpiece.

### BRIEF DESCRIPTION OF THE DRAWINGS

FIG. 1 is a top perspective view of the present pocket hole jig;

FIG. 2 is a fragmentary top perspective view of the present pocket hole jig;

FIG. 3 is a vertical cross-section of the pocket hole jig taken along the line 3-3 of FIG. 1 and in the direction generally indicated;

FIG. 4 is a top plan view of the pocket hole jig of FIG. 1;

FIG. 5 is a rear top perspective view of the present pocket hole jig;

FIG. 6 is a front elevation of the pocket hole jig of FIG. 1;

FIG. 7 is a side elevation of the pocket hole jig of FIG. 1;

FIG. 8 is a rear elevation of the pocket hole jig of FIG. 1;

FIG. 9 is a bottom plan view of the pocket hole jig of FIG. 1;

FIG. 10 is a fragmentary top perspective view of the pocket hole jig of FIG. 1 with portions removed for clarity;

FIG. 11 is a fragmentary top perspective view of the pocket hole jig of FIG. 10;

FIG. 12 is a fragmentary top plan view of the pocket hole jig of FIG. 1;

FIG. 13 is an enlarged fragmentary top elevation of the pocket hole jig of FIG. 12;

FIG. 14 is a side elevation of the pocket hole jig of FIG. 10;

FIG. 15 is a top perspective view of the present pocket hole jig mounted to a workpiece; and

FIG. 16 is a top perspective view of a woodworking assembly illustrating the insertion of fasteners into pocket holes created using the jig of FIG. 1.

### DETAILED DESCRIPTION

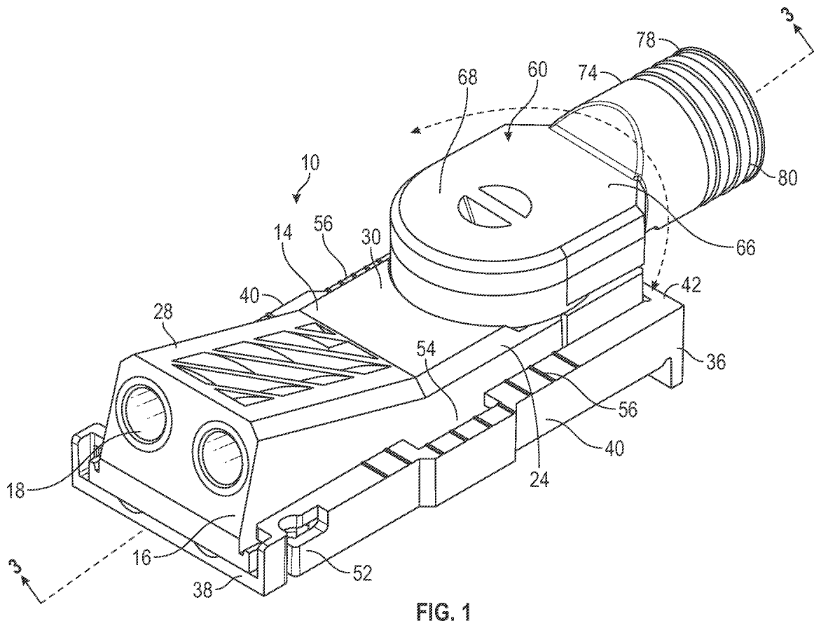

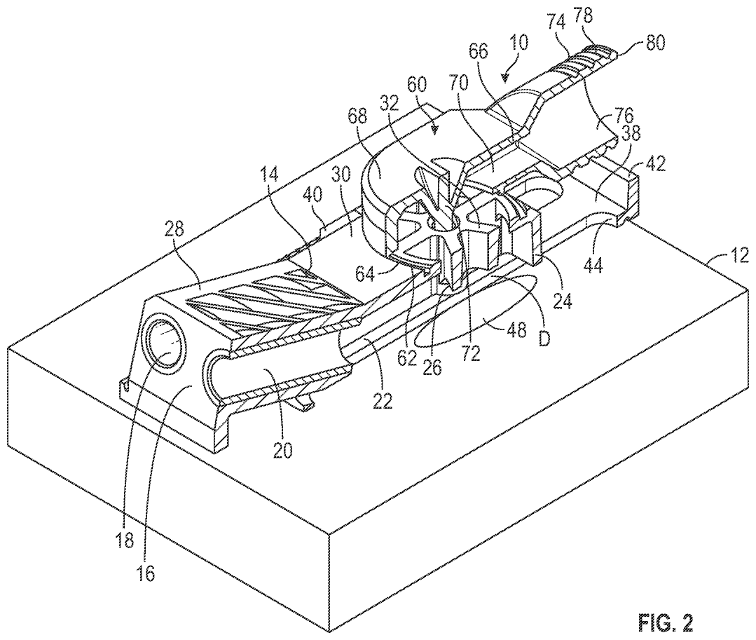

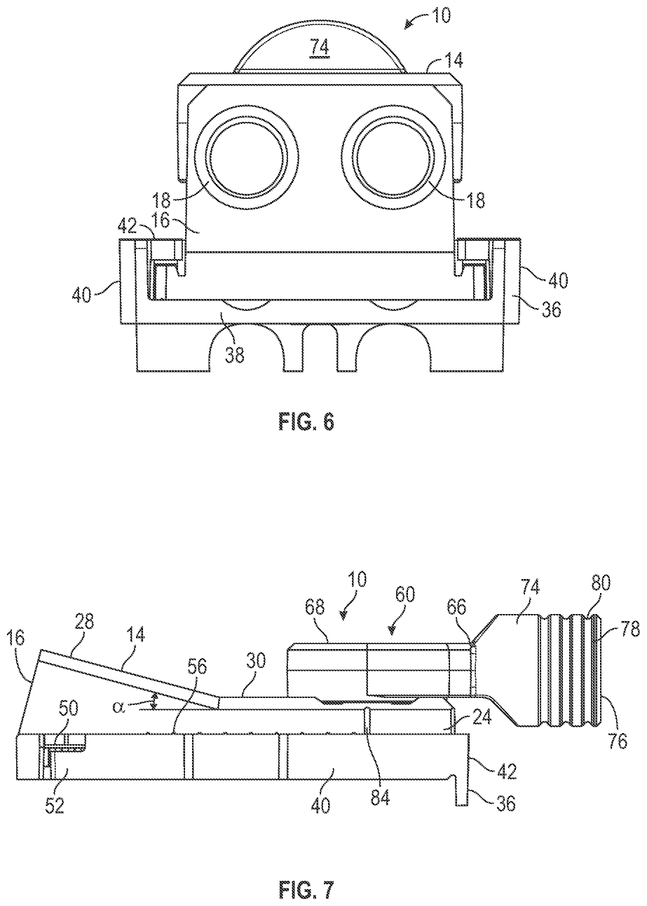

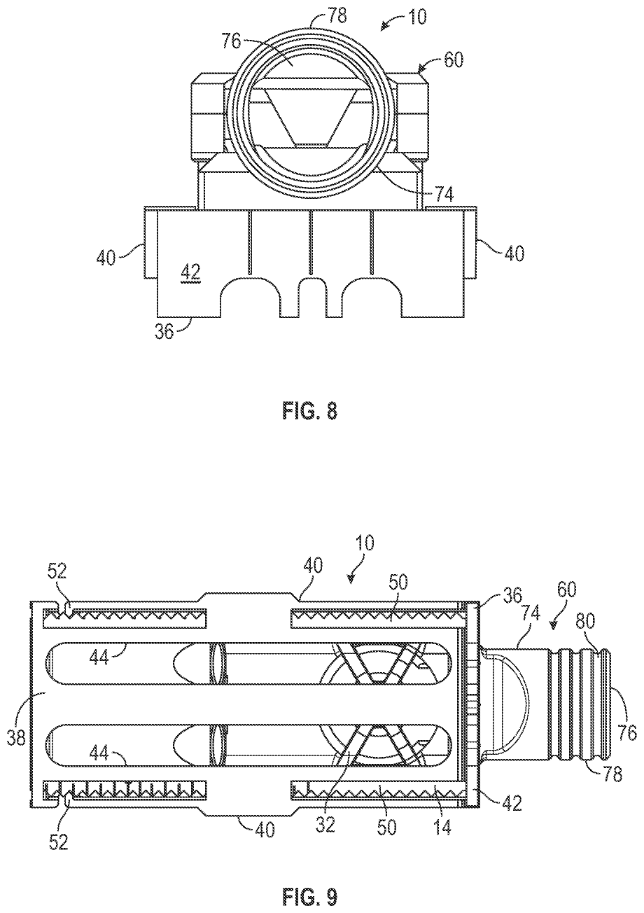

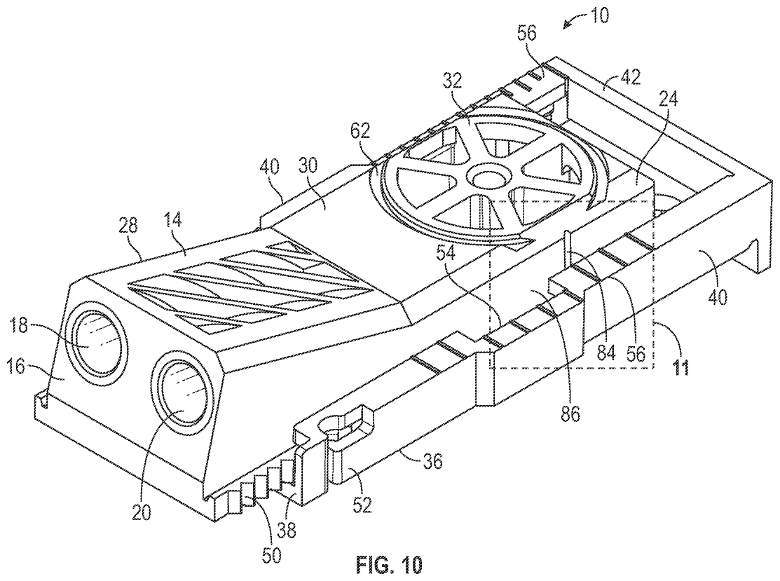

Referring now to FIGS. 1-8, the present pocket hole jig is generally designated 10 and is shown mounted to a workpiece 12 (FIG. 2). The present pocket hole jig 10 is of the portable type and is configured for assisting woodworkers in accurately drilling angularly oriented holes in the workpiece 12 for attaching parts at right angles, as described below. Fasteners inserted through the holes bored by the present pocket hole jig 10 are not easily seen in the finished workpiece 12.

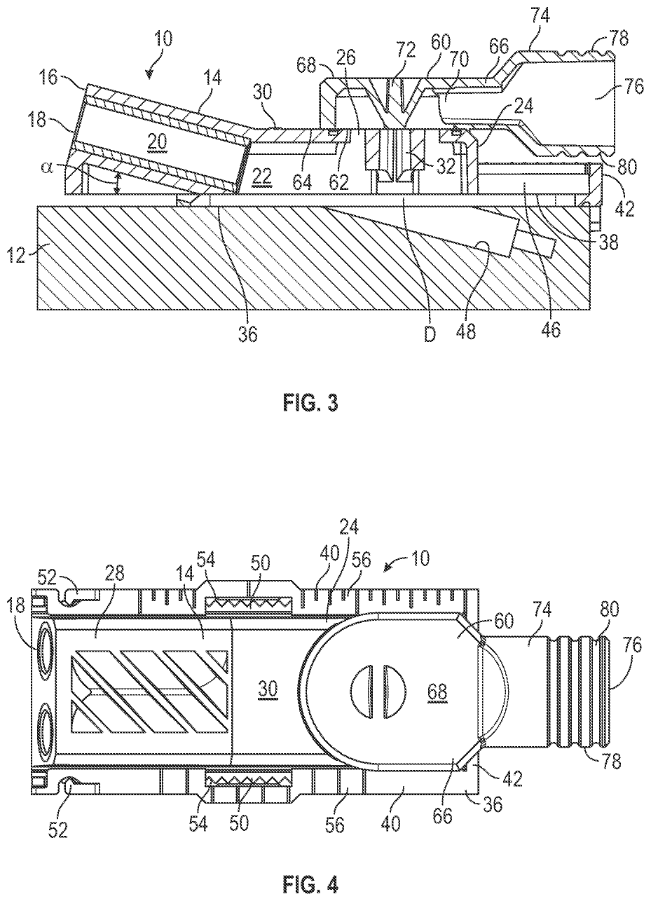

Included in the present pocket hole jig 10 is a body 14 with a first end 16 having at least one drill entry port 18 in communication with a fastener bore 20, which in turn is in communication with an internal drilling chamber 22. A second, opposite end 24 has a chip flute 26 in communication with the drilling chamber 22 (FIGS. 2 and 3). The drill entry ports 18 and the fastener bores 20 are oriented at an elevated angle α relative to horizontal to define the angular attack of the desired fastener. While the size of the angle α may vary to suit the application, in the preferred embodiment, the angle is in the range of 20-40°. As such, a first portion 28 of the body 14 is also elevated at the angle α.

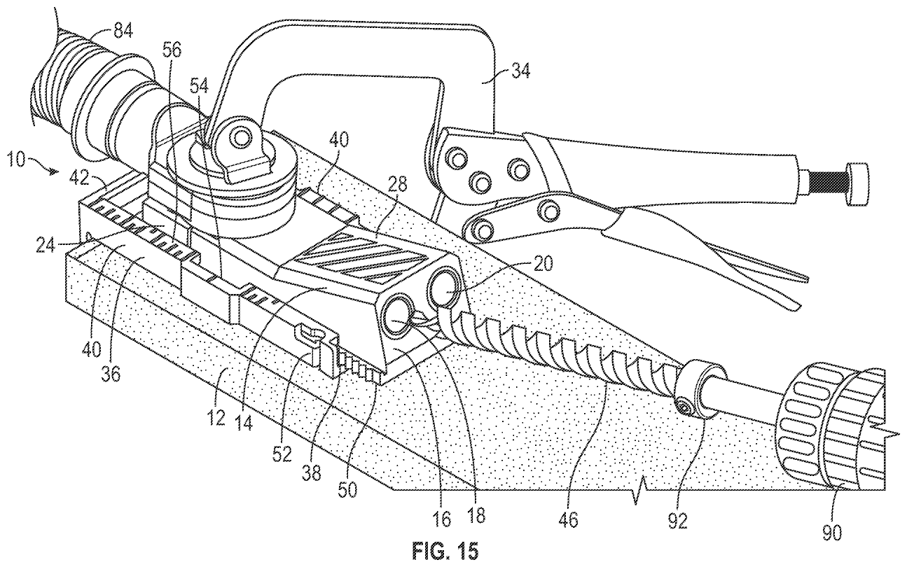

Preferably, the second end 24 is connected to the first portion 28, is generally horizontally-oriented and defines the drilling chamber 22 and the chip flute 26. The drill chip flute 26 creates a fluid communication between the drilling chamber 22 and an upper surface 30 of the second end 24. Preferably, the drill chip flute 26 is circular in shape and is provided with a preferably integral support grid 32 for accommodating a clamp 34 (FIG. 15) used to hold the pocket jig 10 to the workpiece 12 during drilling. By “accommodating” the clamp 34 is meant that sufficient structural support is provided to the jig 10 to withstand the clamping force without collapsing the apparatus. In the preferred embodiment, the drill chip flute 26 is circular and the support grid 32 is generally “star”-shaped, however other configurations are contemplated depending on the application. The drill chip flute 26 is preferably located above a drilling location “D” which is where a drill bit engages the workpiece 12.

Also included on the present pocket jig 10 is a distance adjustment base 36 configured for contact with the workpiece 12 and being configured so that the body 14 is linearly slidable relative to the base for adjusting drill depth and drilling position on the workpiece. In the preferred embodiment, the distance adjustment base 36 is generally tray-shaped, having a generally planar floor 38, a pair of vertically-projecting sidewalls 40 and a rear wall 42. A pair of slots 44 are defined in the floor 38 and are aligned with the drill entry ports 18 and the fastener bores 20 in the body 14. Preferably, the slots 44 are parallel with the side walls 40 and extend almost a length of the floor 38 for allowing passage of a drill bit 46 (FIG. 15) that is inserted into the drill entry ports 18 and the fastener bores 20 for creating desired fastener cores 48 (FIGS. 2, 3, 16) in the workpiece 12.

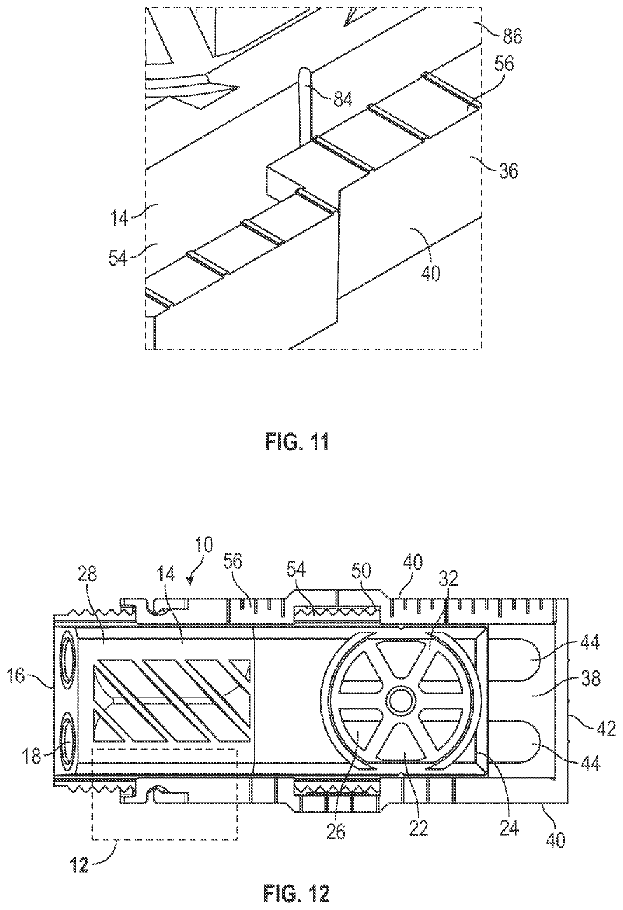

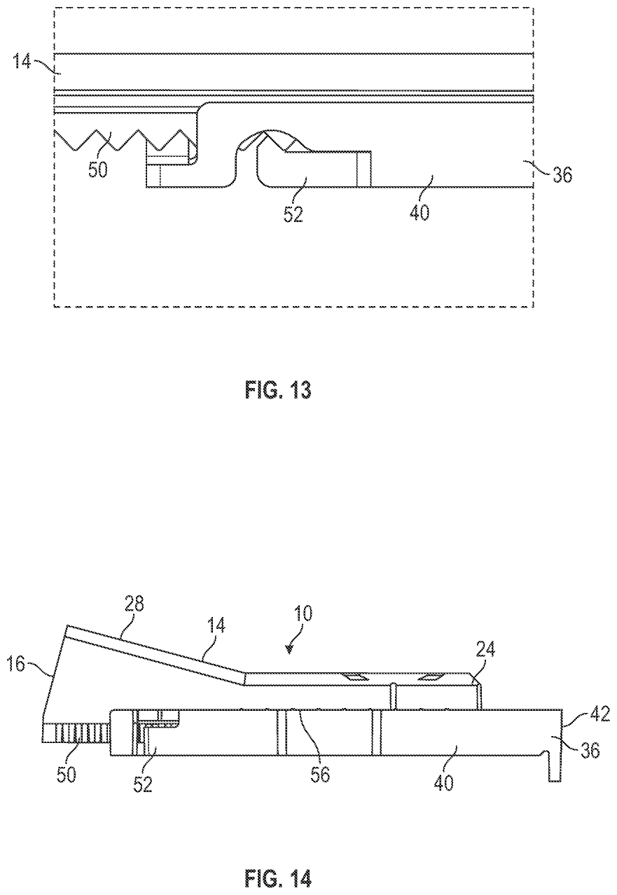

Referring now to FIGS. 4, 5, 9 and 12-14, another feature of the present pocket jig 10 is that the body 14 is linearly indexable relative to the distance adjustment base 36. To this end, the body 14 is provided with laterally-extending jagged saw-tooth edges 50 that are each engaged by a respective biased hook formation 52 associated with the sidewalls 40 of the distance adjustment base 36. It is contemplated that the use of engagement between the saw-tooth edges 50 and the biased hook formation 52 respectively could be located respectively on either one of the body 14 and the distance adjustment base 36.

Engagement between the saw-tooth edge 50 and the hook 52 holds the respective positions of the body 14 and the distance adjustment base 36. As such, linear sliding movement of the body 14 relative to the distance adjustment base 36 is under precise control of the user. In addition, the sidewalls 40 also are provided with at least one opening or window 54 (FIG. 4) through which the saw-tooth edges 50 are visible. Measurement indications 56 in inches, millimeters or centimeters are provided to an upper surface 58 of the sidewalls 40 surrounding the windows 54 so that the user can easily adjust the relative position of the body 14 relative to the distance adjustment base 36 for obtaining the desired position of the fastener cores 48. In an embodiment, the measurement indications 56 are different on each of the sidewalls 40.

Referring now to FIGS. 1-4, another feature of the present pocket hole jig 10 is a dust collector fitting 60 removably attachable to, and in communication with the chip flute 26 on the body 14. In the preferred embodiment, the chip flute 26 has an annular groove 62 that forms an attachment point for the dust collector fitting 60. A depending rib 64 on the dust collector fitting 60 slidingly and rotatably engages the annular groove 62 to provide fully rotatable engagement of the dust collector fitting 60 relative to the body 14.

Included on the dust collector fitting 60 is a main housing 66 with a planar upper surface 68. The main housing 66 defines an inlet chamber 70 that is in communication with both the chip flute 26 and the internal drilling chamber 22 upon connection of the dust collector fitting 60 to the body 14. Further, it is preferred that the main housing 66 and the chip flute 26 are both located above the drilling location “D”.

A support piece 72 on the dust collector fitting 60 is preferably integrally formed with the main housing 66 and is in vertical alignment and contacting relationship with the support grid 32 in the chip flute 26 (FIG. 3). Through this structural support and contact, the dust collector fitting 60 accommodates the clamp 34 for securing the pocket hole jig 10 to the workpiece 12. As such, the support piece 72 withstands the clamping force of the clamp 34 without causing the dust collector fitting 60 to collapse. It will be noted that the clamp 34 is mountable to either the main housing 66 of the dust collector 60, or to the support grid 32 of the drill chip flute 26 for holding the pocket hole jig 10 to the workpiece 12 during drilling.

Another feature of the dust collector fitting 60 is a radially projecting collector tube 74 in fluid communication with the inlet chamber 70, and having an outlet 76. The dust collector fitting 60 is configured to expand in volume as distance increases from the chip flute 26 towards the outlet 76 for enhancing flow of chips generated during drilling In addition, an exterior 78 of the collector tube 74 is provided with at least one external annular groove 80 at a free end 82 near the outlet 76 for securing a vacuum tube 84 (FIG. 15) connected to a conventional shop vacuum or vacuum system as is known in the art. The rotatable attachment of the dust collector fitting 60 means that the user can adjust the position of the collector tube 74 to suit the particular arrangement of shop equipment during the drilling operation. Once the jig 10 is clamped in place as shown, the vacuum tube 84 is removable without changing the position of the dust collector fitting 60. Another feature of the present dust collector fitting 60 is that it is attachable to the jig 10 without additional hardware or fasteners and is freely rotatable relative to the body 14.

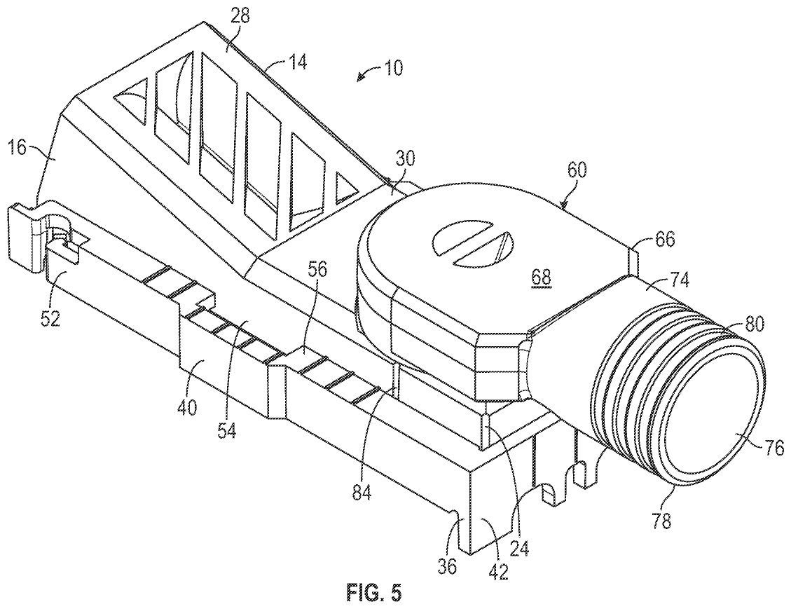

Referring now to FIGS. 5, 7 10 and 11, to further facilitate user adjustment of the body 14 to the distance adjustment base 36, the body 14 is preferably provided with at least one position indicator 86 on at least one side 88 of the body. Each indicator 86 is preferably a vertical groove cut into the side 88 of the body 14 and is positioned in operational proximity to the measurement indications 56 on the adjustment base sidewalls 40 to provide the user with a reference point of the relative position of the body 14 and the distance adjustment base 36.

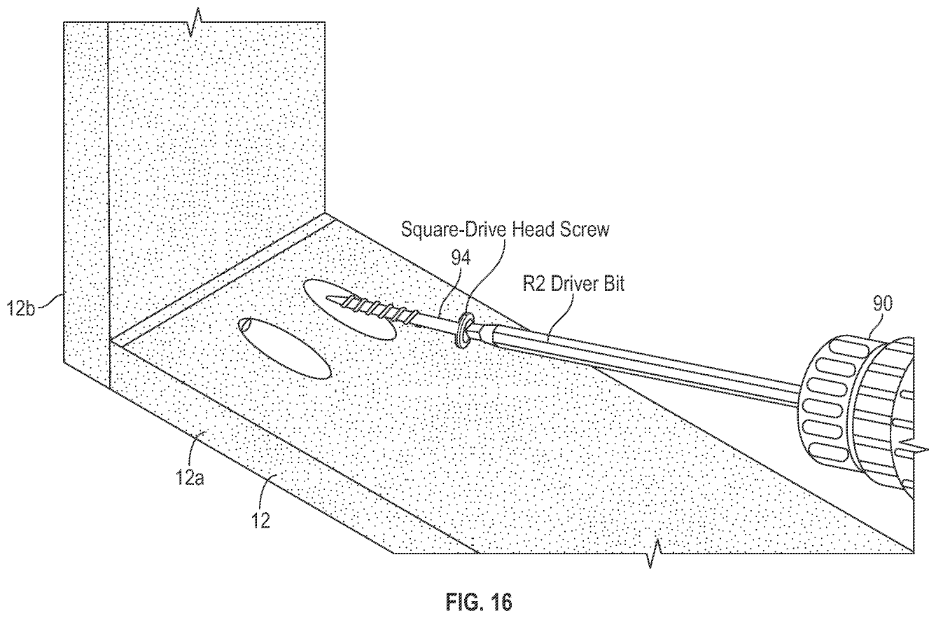

Referring now to FIGS. 15 and 16, operation of the present pocket hole jig 10 is depicted. First, the pocket hole jig 10 is placed appropriately on the workpiece 12 with the distance adjustment base 36 flat on the workpiece. Next, the body 14 is linearly adjusted relative to the base 36, using the indexing feature, namely the engagement between the saw-tooth edges 50 and the biased hook formations 52. Use of the measurement indications 56 and the position indicator 86 is also preferred for assisting achieving accurate location of the resulting fastener core 48.

Once the pocket hole jig 10 is properly positioned and adjusted, the clamp 34 is used to secure the jig to the workpiece 12. As was noted above, due to the construction of the chip flute 26 and the dust collector fitting 60, whether or not the dust collector fitting is in place, the clamp is engageable on the pocket hole jig 10 at the location of the chip flue, which is also located above the drilling location “D” without causing damage to the jig 10. After clamping the pocket hole jig 10 in position, a drill 90 with the drill bit 46 is used to insert the drill bit into the drill entry port 18. If desired, a collar 92 is mountable on the drill bit 46 to ensure a desired depth of drilling. Once

As seen in FIG. 16, once the pocket hole jig 10 is used to create the fastener cores 48, suitable fasteners 94 are used to secure the workpieces 12a, 12b together at right angles. It is also contemplated that the two workpieces are joined coplanar with each other. It is contemplated that the present pocket hole jig 10 including the body 14, the distance adjustment base 36 and the dust collector fitting are manufactured of plastic, engineered materials, wood, metal or the like.

While a particular embodiment of the present pocket hole jig with dust collection has been described herein, it will be appreciated by those skilled in the art that changes and modifications may be made thereto without departing from the invention in its broader aspects and as set forth in the following claims.

1. A pocket hole jig, comprising:
a body with a first end having at least one drill entry port in communication with an internal drilling chamber, and a second, opposite end having a chip flute in communication with said drilling chamber;
a distance adjustment base configured for contact with a workpiece and being configured so that said body is linearly slidable relative to said base for adjusting drill depth and drilling position of the workpiece; and
a dust collector fitting removably attachable to, and in communication with said chip flute;
at least one of said dust collector fitting and said chip flute being configured for accommodating a clamp for securing said jig to the workpiece.

2. The pocket hole jig of claim 1, wherein said dust collector fitting is rotatable relative to said chip flute.

3. The pocket hole jig of claim 2, wherein said dust collector fitting includes a radially projecting collector tube.

4. The pocket hole jig of claim 3, wherein said collector tube has external grooves at a free end for securing a vacuum tube.

5. The pocket hole jig of claim 1, wherein said body is linearly indexable relative to said distance adjustment base.

6. The pocket hole jig of claim 5, wherein said indexable relationship is provided by the use of engagement between saw-tooth edges and a biased hook formation respectively on one of said body and said distance adjustment base.

7. The pocket hole jig of claim 5, wherein said body is provided with laterally-extending saw-tooth edges that are each engaged by a respective biased hook formation associated with the sidewalls of the distance adjustment base.

8. The pocket hole jig of claim 1 wherein said dust collector fitting and said chip flute are located above said drilling chamber.

9. The pocket hole jig of claim 1, wherein both of said dust collector fitting and said chip flute are configured for accommodating a clamp for securing said jig to the workpiece.

10. The pocket hole jig of claim 1, further including measurement indications on said distance adjustment base for displaying a position of said body relative to said distance adjustment base.

11. The pocket hole jig of claim 10, wherein said body has a position indicator in operational proximity to said measurement indicators for facilitating location of said body relative to said distance adjustment base.

12. A pocket hole jig, comprising:
a body with a first end having at least one drill entry port in communication with an internal drilling chamber, and a second, opposite end having a chip flute in communication with said drilling chamber;
a distance adjustment base configured for contact with a workpiece and being configured so that said body is linearly slidable relative to said base for adjusting drill depth and drilling position of the workpiece; and
said chip flute being provided with a support grid for accommodating a clamp for securing said jig to the workpiece.

13. The pocket hole jig of claim 12, wherein said chip flute is located above said drilling chamber.

14. The pocket hole jig of claim 12, further including a dust collector fitting being rotatably mounted relative to said chip flute.
